(19) United States
(12) Patent Application Publication
(10) Pub. No.: US 2018/0121859 A1
(43) Pub. Date: May 3, 2018

(54) COMPUTER-IMPLEMENTED SYSTEM AND METHOD FOR PROVIDING ON-DEMAND EXPERT ADVICE TO A CONSUMER

(71) Applicant: ChickAdvisor Inc., Toronto (CA)

(72) Inventor: Alejandro J. de Bold, Toronto (CA)

(73) Assignee: ChickAdvisor Inc., Toronto (CA)

(21) Appl. No.: 15/649,883

(22) Filed: Jul. 14, 2017

Related U.S. Application Data
(60) Provisional application No. 62/416,837, filed on Nov. 3, 2016.

(30) Foreign Application Priority Data
Apr. 28, 2017 (CA) 2965457

(51) Int. Cl. G06Q 10/06; G06Q 30/00; G06N 5/04; G06Q 30/08

(52) U.S. Cl. CPC G06Q 10/063112; G06Q 30/08; G06N 5/04; G06Q 30/016

(57) ABSTRACT

Described is a computer system and computer-implemented method for providing on-demand advice through a computer communication network to a consumer. The consumer, from a network-connected computing device, makes an information request relating to an object, such as a product or service through their smartphone or computing device. The request is received by a computer server which analyzes the information request to identify at least one skill required to knowledgeably respond to the information request. The server matches the information request with an available expert having the skills required to knowledgeably respond to the information request. The computer server then sends the information request to the available expert, typically a person, who engages with the consumer through their own network-connected computing device. Once the engagement has concluded between the consumer and the expert, the server determines a price for the engagement to be remitted to the available expert.

### FIELD OF THE INVENTION

The present specification relates generally to a computer-implemented real-time question and answer platform and more specifically relates to a system and method for providing on-demand expert advice to a consumer or requestor through a real-time question and answer platform for connecting consumers and available experts.

### BACKGROUND OF THE INVENTION

Before purchasing a product in store or online, potential consumers tend to either speak to a sales person or use their smartphone to learn more about the products they are interested in purchasing. This include the common practice known as showrooming. Where merchandise is examined in a retail store or other offline setting and then bought online, potentially at a lower price.

Today, more than 60% of all shopping experiences are influenced by digital. Smartphones, especially for millennials, are the primary platform for research and communication. This said, when potential consumers cannot find the product information they are looking for, they may turn to researching ratings, reviews and recommendations online. During an online search, potential consumers may rely heavily on ratings, reviews and recommendations of past consumers for product information, product comparisons, prices, advantages, disadvantages, etc.

While helpful, many online ratings, reviews and recommendations are provided by lay past consumers, and are not a source of expert advice. The amount of time spent and the lack of expertise provided from conducting online search queries for retrieving product information is time-consuming, inefficient and ineffective.

Accordingly, there remains a need for improvements in the art.

### SUMMARY OF THE INVENTION

In accordance with an aspect of the invention, there is provided a system, method and computer program product for providing on-demand expert advice to a consumer through a real-time question and answer platform for connecting consumers and available experts.

According to a further embodiment, the present invention provides a computer-implemented method for providing on-demand expert advice through a computer communication network to a consumer operating a network-connected computing device, the method comprising: receiving an information request relating to an object from the computing device of the consumer; analyzing the information request to identify at least one skill required to knowledgeably respond to the information request; matching the information request with an available expert having the at least one skill required to knowledgeably respond to the information request; sending the information request to the available expert so the available expert may engage with the consumer; and following conclusion of the engagement between the consumer and the available expert, determining a price for the engagement to be remitted to the available expert.

According to an embodiment of the invention, the present invention provides a computer system for providing on-demand expert advice through a computer communication network to a consumer operating a network-connected computing device, the computer system comprising: a computer communication network; a consumer computing device connected to the computer communication network; a computer server connected to the computer communication network, the server including computer-readable instructions, which when executed configure the computer server to: receive information requests from the consumer computing device; analyze the information request to identify at least one skill required to knowledgeably respond to the information request; match the information request with an available expert having the at least one skill required to knowledgeably respond to the information request; send the information request to the available expert so the available expert may engage with the consumer; and following conclusion of the engagement between the consumer and the available expert, determine a price for the engagement to be remitted to the available expert; and at least one computing device operated by the available expert connected to the computer communication network.

According to a further embodiment, the present invention provides a computer program product for providing on-demand advice through a computer communication network to a consumer operating a network-connected computing device, the computer program product comprising: a storage medium configured to store computer-readable instructions; the computer-readable instructions including instructions for, receiving an information request relating to an object from the computing device of the consumer; analyzing the information request to identify at least one skill required to knowledgeably respond to the information request; matching the information request with an available expert having the at least one skill required to knowledgeably respond to the information request, sending the information request to the available expert so the available expert may engage with the consumer; and following conclusion of the engagement between the consumer and the available expert, determining a price for the engagement to be remitted to the available expert.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a system diagram for a system for providing on-demand expert advice to a consumer through a real-time question and answer platform for connecting consumers and available experts according to an embodiment of the invention;

FIG. 2 is a flow diagram of a method for providing on-demand expert advice to a consumer according to an embodiment of the invention;

FIG. 3 is a global dashboard for a real-time question and answer platform for connecting consumers and available experts according to an embodiment of the invention;

FIG. 4 is a system and user administration interface according to an embodiment of the invention;

FIG. 5 is a user interface according to an embodiment of the invention;

FIG. 6 is a client administration interface according to an embodiment of the invention;

FIG. 7 is a channel interface according to an embodiment of the invention;

FIG. 8 is a further channel interface according to an embodiment of the invention;

FIG. 9 is an expert dashboard according to an embodiment of the invention;

FIG. 10 is an expert detail page according to an embodiment of the invention;

FIG. 11 is an expert pending approval interface according to an embodiment of the invention;

FIG. 12 is an expert application detail page according to an embodiment of the invention;

FIG. 13 is a suspended expert administration page according to an embodiment of the invention;

FIG. 14 is a knowledge channel overview according to an embodiment of the invention;

FIG. 15 is an approved expert page according to an embodiment of the invention;

FIG. 16 is a channel dashboard according to an embodiment of the invention;

FIG. 17 is a process for expert registration according to an embodiment of the invention;

FIG. 18 shows interfaces for active experts according to an embodiment of the invention;

FIG. 19 are channel and campaign management and application interfaces according to an embodiment of the invention;

FIG. 20 is an interaction interface according to an embodiment of the invention;

FIG. 21 shows types of communication channels according to an embodiment of the invention;

FIG. 22 is flow diagram for directly and indirectly inputting an information request according to an embodiment of the invention;

FIGS. 23A and 23B show a data logic and processing layer according to an embodiment of the invention;

FIG. 24 is a routing, matching and pricing engine according to an embodiment of the invention; and

FIG. 25 is a flow diagram showing advanced query identification and continuous optimization through machine learning according to an embodiment of the invention.

Like reference numerals indicated like or corresponding elements in the drawings.

### DETAILED DESCRIPTION OF THE EMBODIMENTS

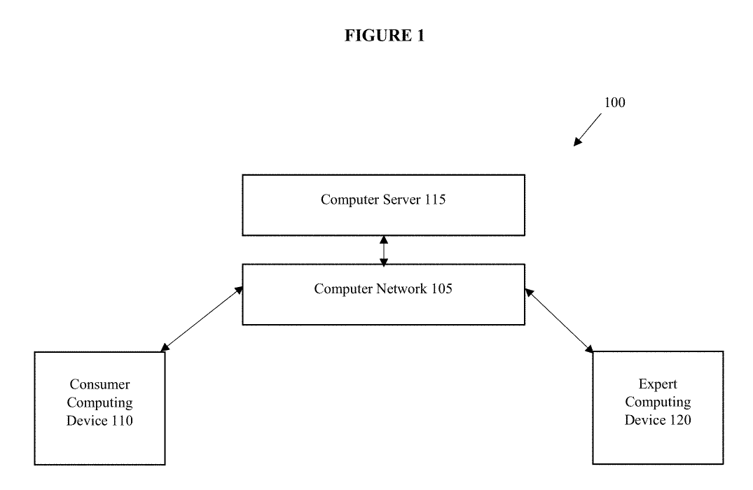

According to an embodiment as shown in FIG. 1, system 100 shows a minimal configuration for a system for providing on-demand expert advice to a consumer through a real-time mobile question and answer platform for connecting consumers and experts may comprise a computer communication network 105, which may itself comprise one or more computer communication networks whether wired or wireless networks that enable communication between the various other components of the system 100, a network-enabled computing device 110 operated by a requestor such as a consumer connected to the computer network 105, a network-enabled computing device 120 operated by an available expert connected to the computer network 105, and a computer server 115 connected to the computer network 105. Computing devices 110 and 120 may comprise a processor, a display, a memory, a transceiver and an input mechanism, and may be any suitable computing device such as a desktop computer, laptop computer, tablet computer, smartphone or other mobile computer device. Computing device 110 may be configured to send over a computer network 105 an information request for an object such as a product or service or person, such a consumer-facing application whether standalone or web-based. The information request may be input by the consumer or requestor by voice input, SMS, a messaging service, a third party mobile application or a third-party website. Also, note that the terms consumer and requestor are used interchangeably throughout this description; the term consumer is intended to include anyone who makes an information request.

The computer server 115 may contain an engagement routing, matching and pricing engine 2016 and may receive information requests over the computer network 105 from one or more consumers via their computing devices 110. There may be a large number of consumers and a large number experts using the system 100 at the same time, in which case the computer server 115 may comprise more than one computer providing the services of the computer server 115 software as described herein. The functionality of the software on the computer server 105 will be described in greater detail below, but as an overview it functions to identify the skills required for an expert to knowledgeably answer the information request, through for example, keyword recognition, and then match the information request with an available expert using information identified through a query to an expert database accessible to the computer server 115, notify the available expert of the pending information request and enable them to enter an engagement or interaction with the consumer which may be facilitated by the computer server 115. According to an embodiment, the information request may be matched with the expert based on category and level of expertise.

According to an embodiment, level of expertise may be determined by one of three methods: an absolute method, a computed method, or a hybrid method. Absolute expertise may result from the expert having submitted credentials to the platform. The credentials may have been verified for the expert to engage in a specific question type or a channel administrator may have elected to assign specific experts to a channel. Computed expertise may be defined as a rating or skill level that may be derived over time and calculated using data inputs associated with a query, feedback from the consumer, and/or machine learning. Hybrid expertise may result from the expert having been added to a channel based on absolute assignment and the expert's actual performance may be graded over time to establish what types of questions, if any, the expert is capable of answering or engaging with. For example, an expert may be a fully qualified electrician who speaks English and French, but in an engagement with a consumer, the expert may be given a poor rating due to the expert's inability to communicate clearly in French. In this hybrid expertise model, the electrician may be qualified but may be disqualified from future queries from consumers where the input query is French.

Following completion of this consumer-expert engagement, the computer server 115 determines a price for the consumer-expert engagement that is to be later remitted to the expert, such as by the brand company to which the information request relates. Pricing for an engagement may be determined by calculating an interaction value using multi-stage optimization, wherein multi-stage optimization may include pre-defined fixed pricing and/or dynamic pricing and price discovery. Price discovery may include querying cost per click or cost per engagement in another (e.g. parallel) online media exchange or platform in real-time. Additional details of price determination are provided further below.

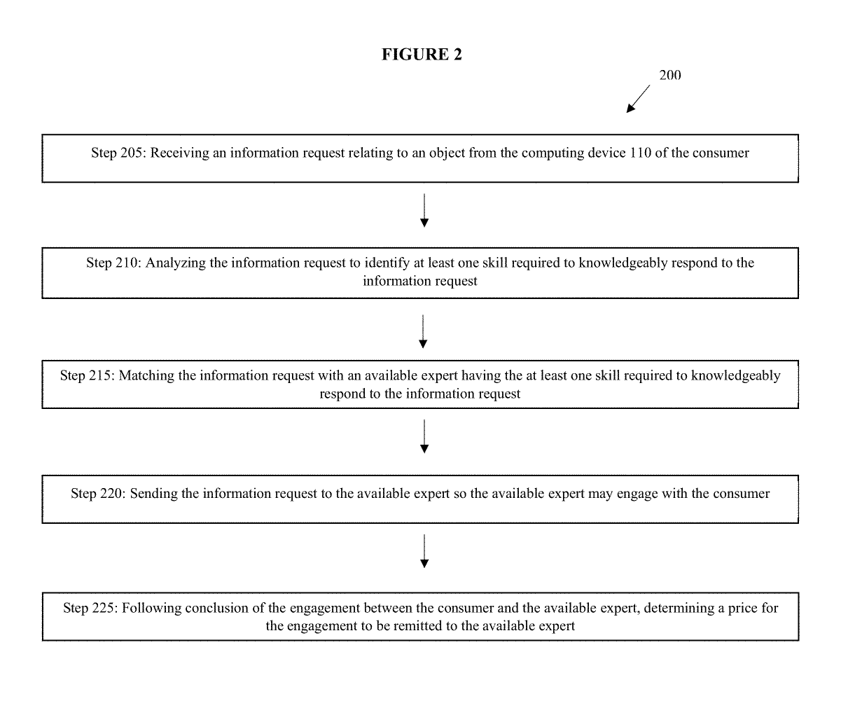

According to an embodiment as shown in FIG. 2, a method 200 for providing on-demand expert advice to a consumer through a real-time mobile question and answer platform for connecting consumers and experts may include receiving an information request relating to an object from the computing device 110 of the consumer in step 205. The method 200 may further include analyzing the information request to identify at least one skill required to knowledgeably respond to the information request in step 210 and then matching the information request with an available expert having the at least one skill required to knowledgeably respond to the information request in step 215. The method 200 may then send the information request to the available expert so the available expert may engage with the consumer in step 220 and following conclusion of the engagement between the consumer and the available expert, determine a price for the engagement to be remitted to the available expert in step 225.

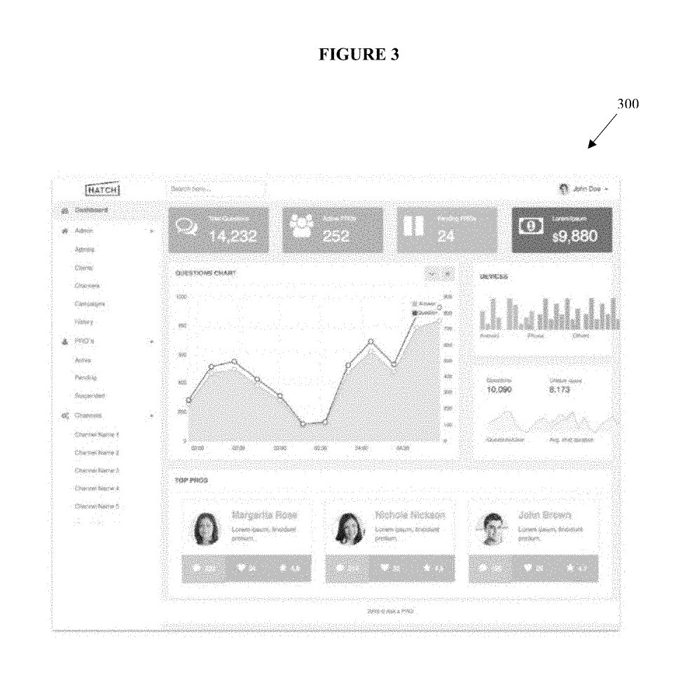

According to an embodiment as shown in FIGS. 3-16, the computer server 115 may include software which provides a web-based administration platform for managing an on-demand platform which itself is software for configuring computer server 115 to carry out the features described herein.

As shown in FIG. 3, a global dashboard interface 300 may illustrate a status for the platform. The global dashboard 300 may display information to the administrator such as total active professionals, total questions asked, total active users, types of devices used, and total money earned.

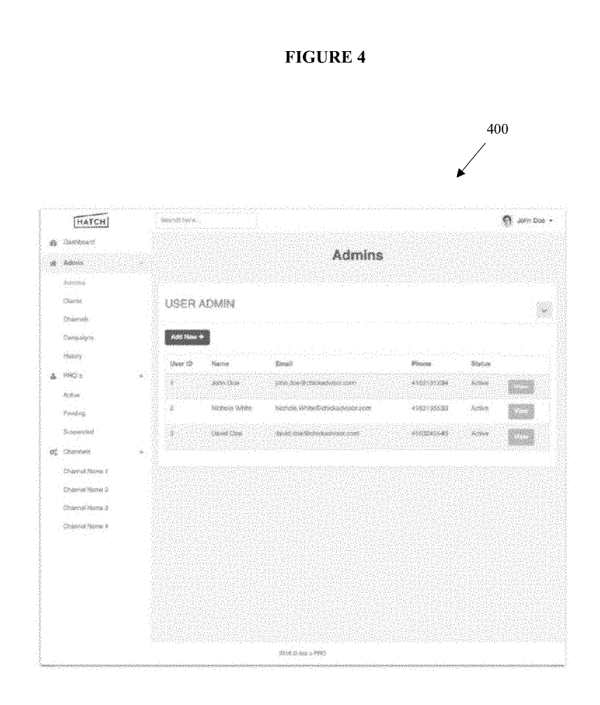

As shown in FIG. 4, the administration platform may include a user administration interface 400 which may allow the addition of users to manage or administer the platform. The interface screen shown displays current users by name, email address, phone number, and status. The platform may be accessed by users through a web browser or a mobile browser. Users may include experts, who are identified as “PRO's” in this screen display.

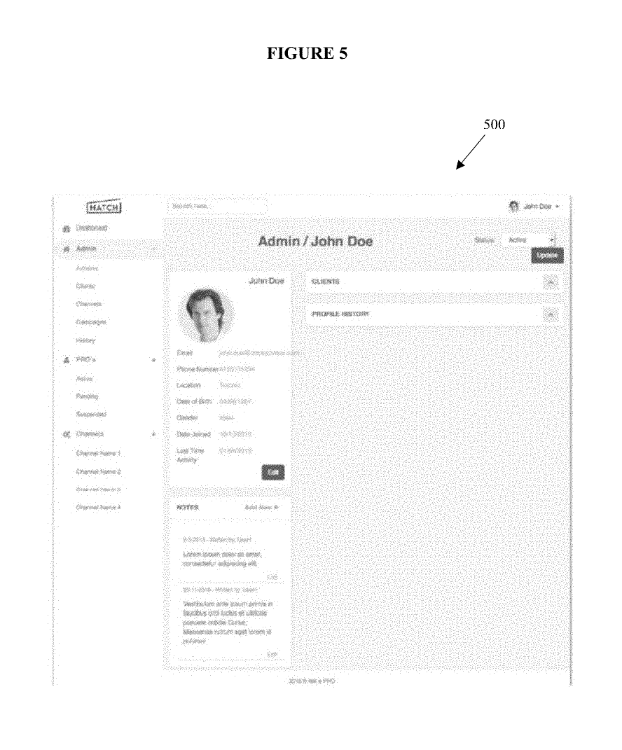

As shown in FIG. 5, a user interface 500 may display an admin user's account information including information such as email address, phone number, location, date of birth, gender, date joined, and last date of activity. Admin users may manage access, passwords and history of activities using this interface. Admin users may also create and manage accounts for other users and clients, and create and administer channels.

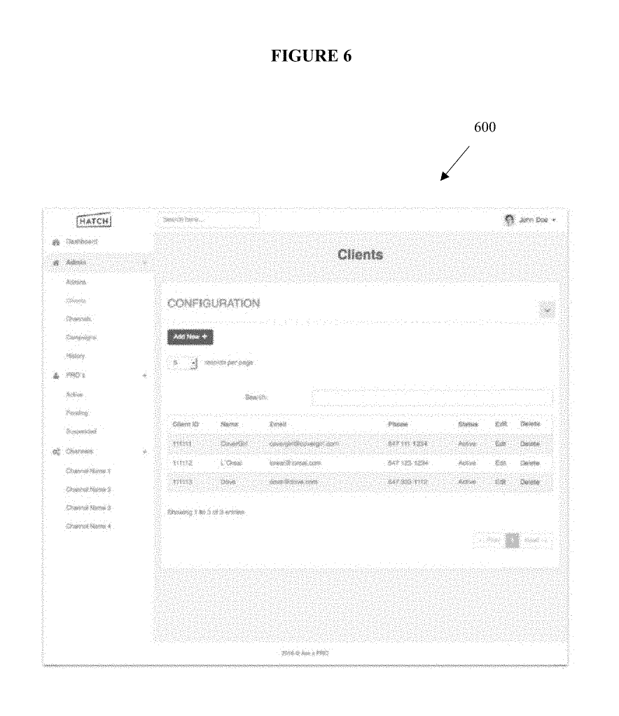

As shown in FIG. 6, a client administration interface 600 may provide access to clients. Clients may be individuals or companies who have agreed to pay experts for their engagements with consumers about certain objects, typically these will be their own products or services. Each client may be provided access to specific sub-components of the administration interface such as the ability to create channels for recruiting on-demand experts to respond to consumer information requests.

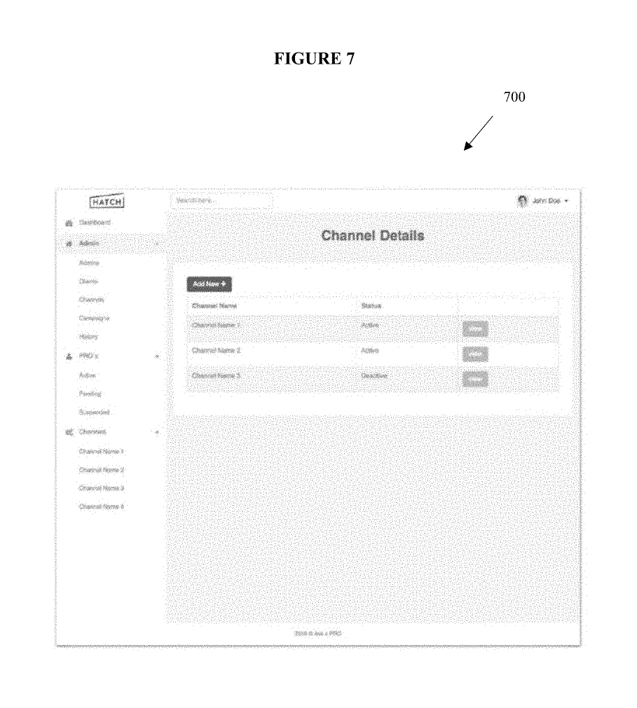

As shown in FIG. 7, a channel interface 700 may allow for the creation and management of channels. According to an embodiment, a channel may be a domain of expertise and may have specific criteria. A channel may be created as open, private or closed. An open channel may allow for any expert to join without limitations. A private channel may require experts to meet defined qualification criteria and a may be managed by platform administrators or the clients themselves. A closed channel is inactive. According an embodiment, a closed channel may only be deleted a certain period of time after deactivation, for example, at least seven years.

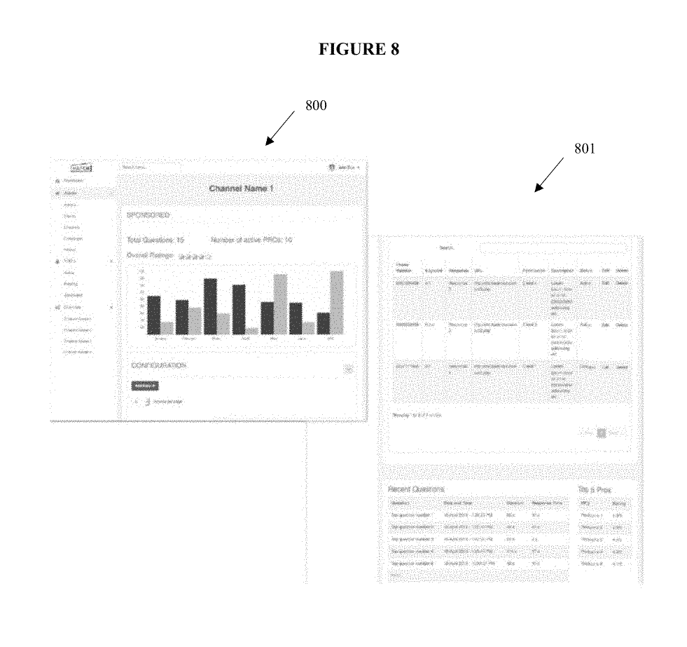

As shown in FIG. 8, each active channel may be assigned a dashboard as shown in dashboard screens 800 and 801, which may be accessed through a web browser or a mobile browser. Access to the dashboard may be granted to clients by channel administrators. Clients may view the performance of the channel through metrics such as volume, quantity and quality. The dashboard may further include customizable performance metrics such as chat duration, compensation and cost of interactions. Through the dashboard, a channel administrator may manage experts, accept new experts, view existing experts and suspend or remove experts.

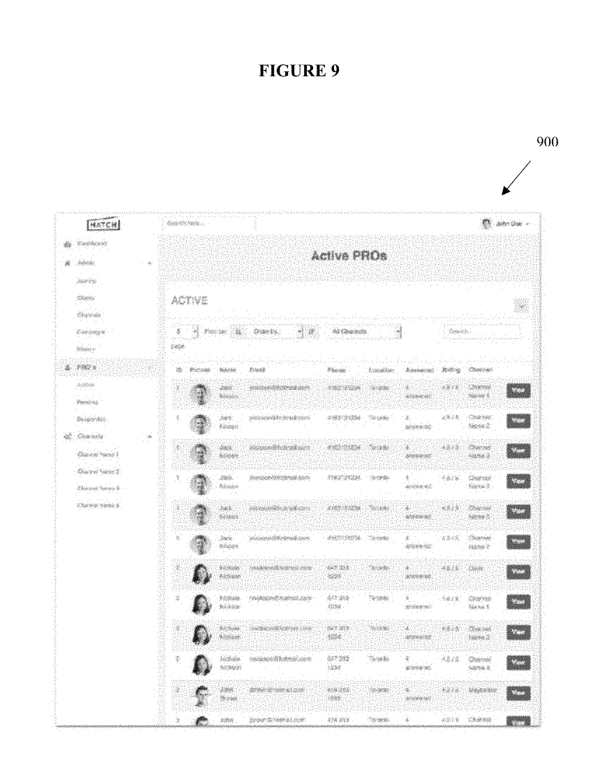

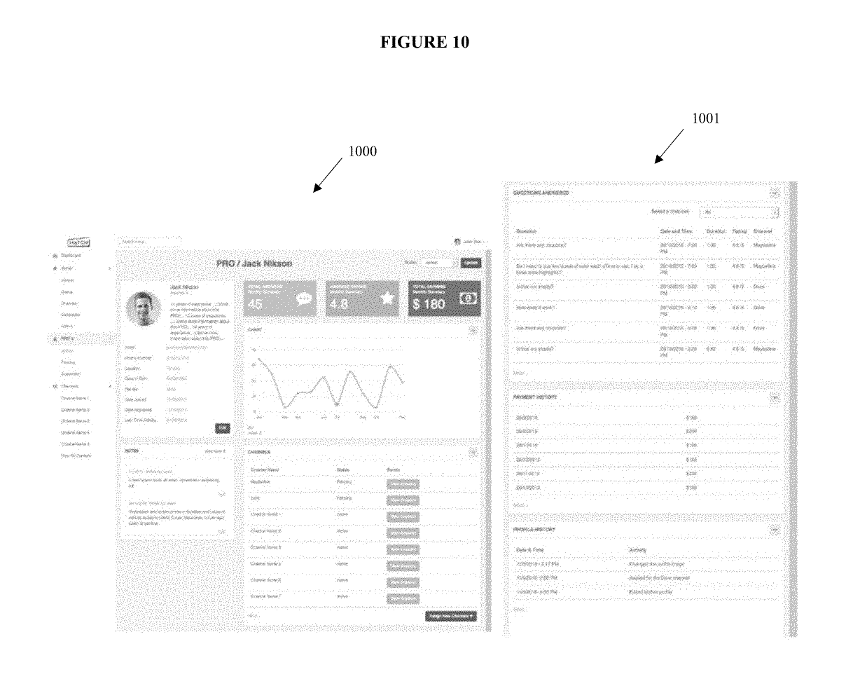

Granular level reporting and management may be required to ensure high quality service from experts. As shown in FIG. 9, active experts may be displayed in pro user dashboard 900 and viewed by administrators or clients. As shown in a pro user detail page 1000 as shown in FIG. 10, detailed information, such as personal data, payment history, ratings, total answers, questions answered, historical profile edits and accepted channels, about an expert may be displayed.

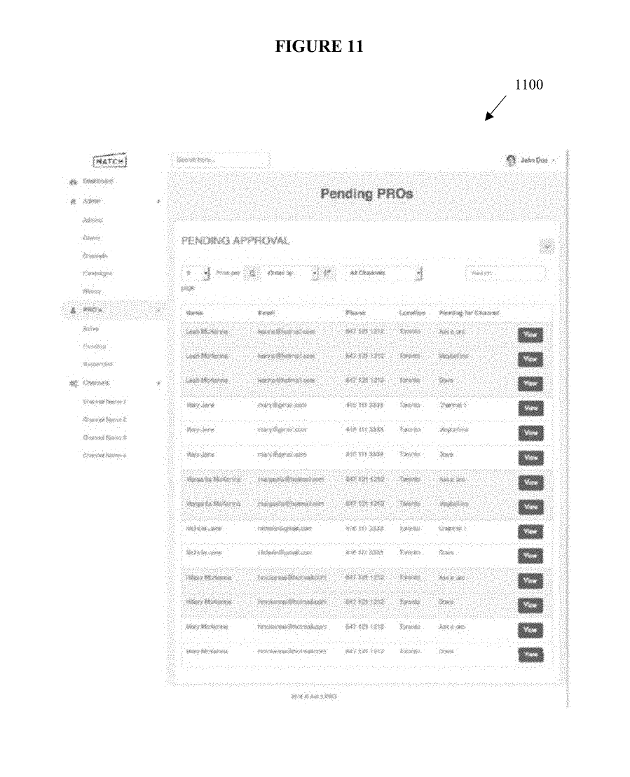

As shown in FIG. 11, an admin user interface screen 1100 may display a list of experts pending approval whereby the administrator or client may approve or deny a request from a pending expert.

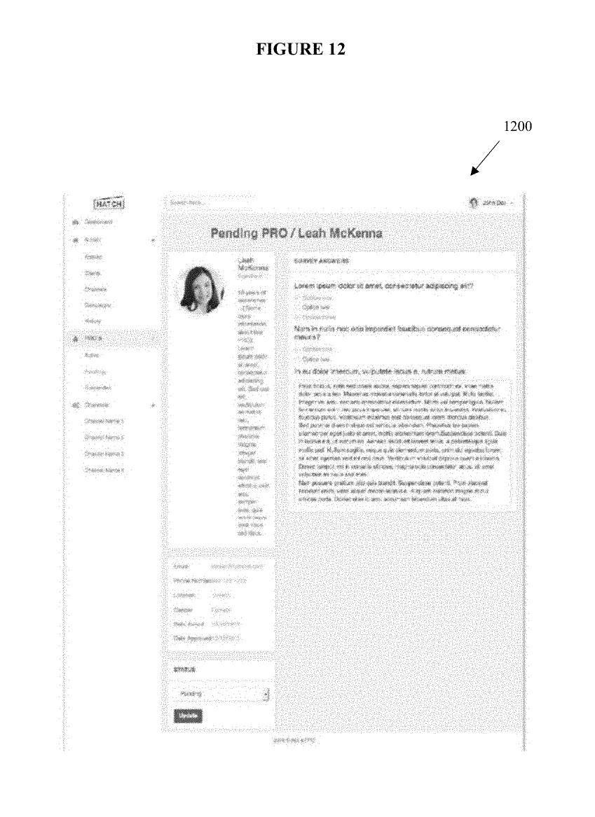

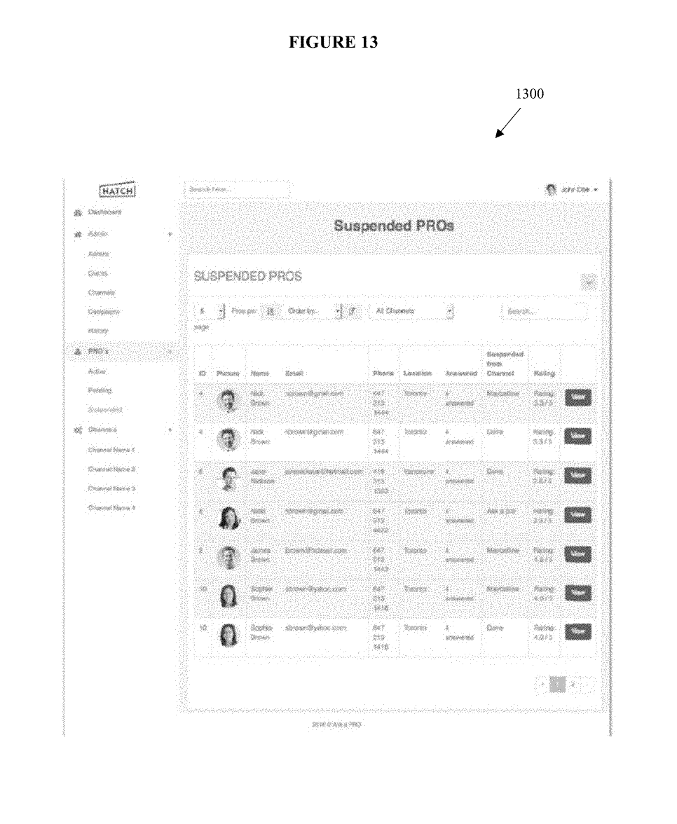

As shown in FIG. 12, the administrator or client may view the pending expert's personal page 1200 detailing the user's pro application before approving or denying the request. As shown in FIG. 13, administrators may temporarily or permanently suspend experts from any or all channels and view them via a suspended pros admin page 1300.

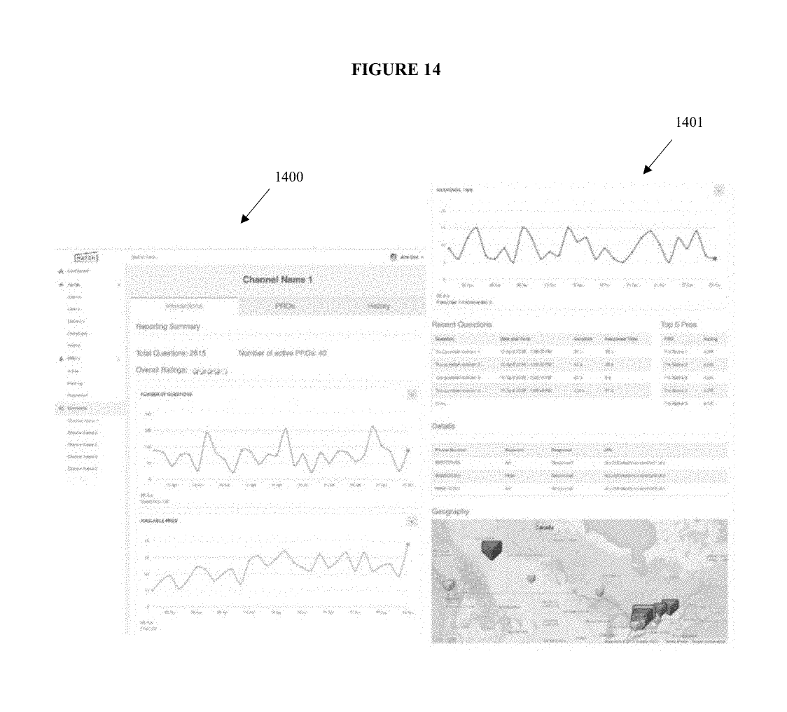

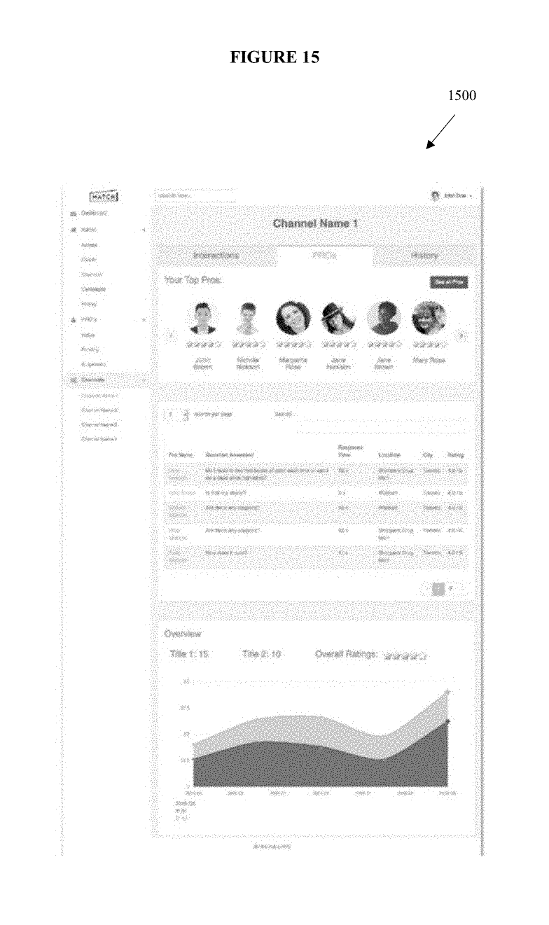

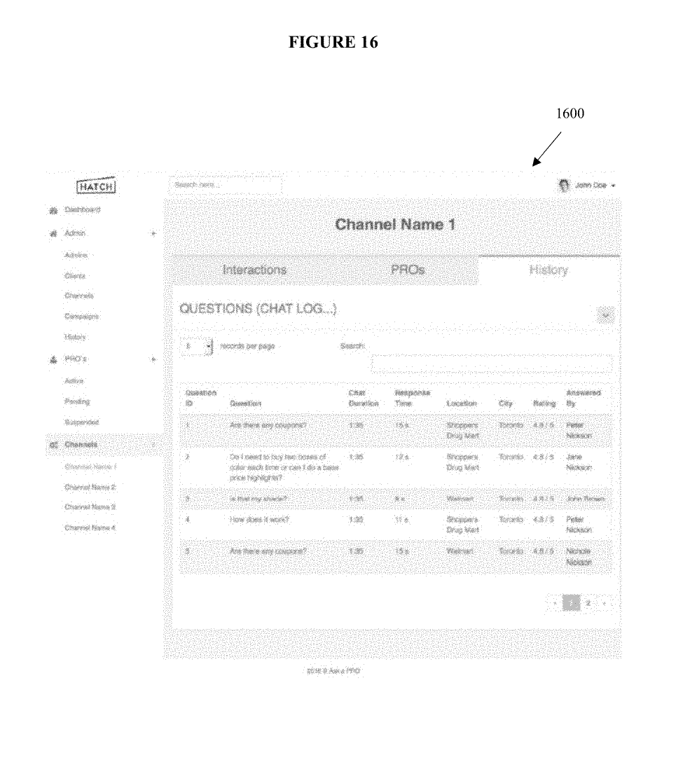

Knowledge channels may represent domains of expertise that may be created and administered within the platform. As shown in FIG. 14, a channel dashboard 1400 may display an overview of the channel. The channel dashboard may display a reporting summary, which may include topline metrics such as volume of questions, response times and number of experts available to answer questions. As shown in FIG. 15, the channel dashboard may display a screen 1500 showing a list of active experts for that channel. As shown in FIG. 16, the channel dashboard may display a screen 1600 showing a full history of interactions between experts and requestors or consumers for that particular channel.

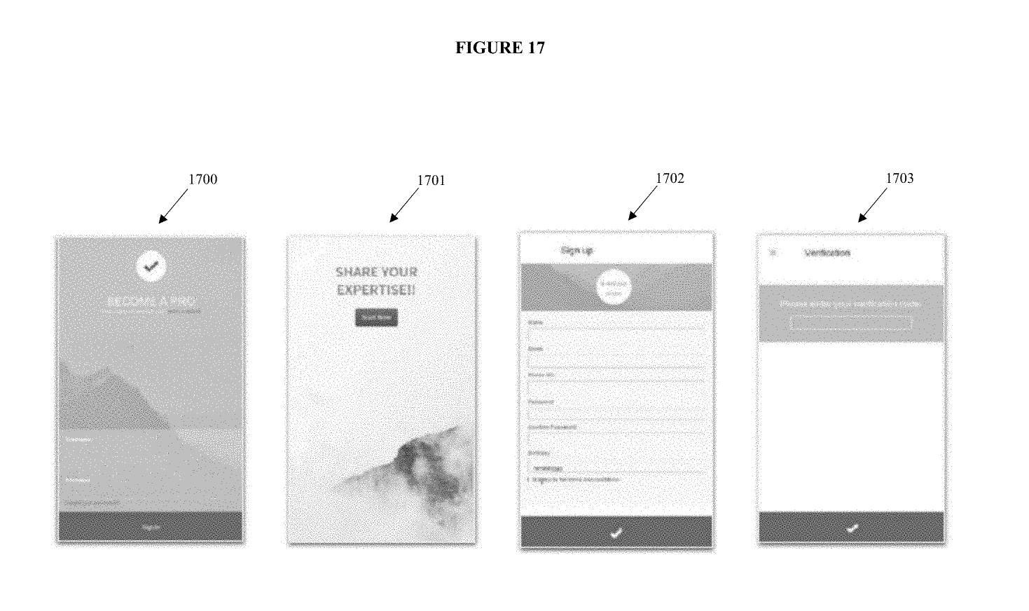

As shown in FIG. 17, experts may initially access the platform registration process 1700 through a mobile software application or a web browser upon a four-step registration process through screens 1701, 1702, 1703 and 1704. According to an embodiment, for enterprise integration, expert registration may occur through application program interface (API) connections between an expert server and a third party.

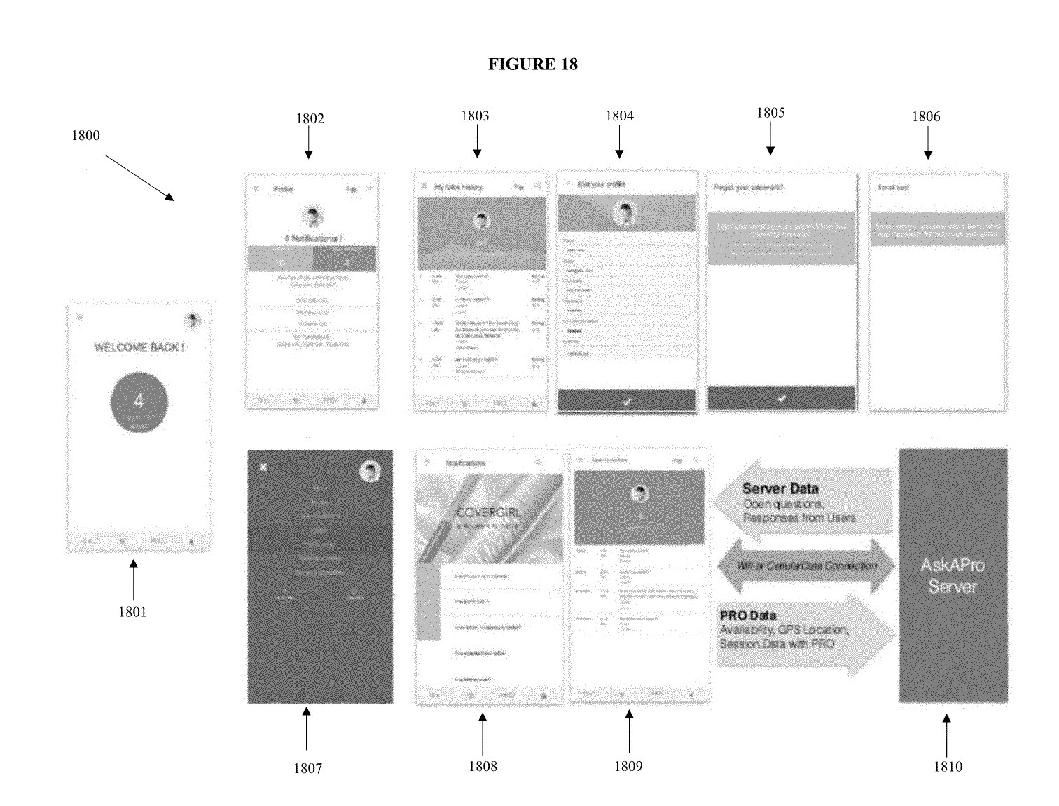

As shown in FIG. 18, experts may access an expert platform 1800 and conduct various tasks as shown in screens 1801 to 1809. Experts may view pending information requests in screen 1801, view an account dashboard 1802, view history of past interactions in screen 1803, edit registration information in screen 1804, reset passwords as shown in 1805 and with a confirmation as in screen 1806, navigate the platform 1807, apply to channels created by clients or administrators 1808, and view open questions 1809. When the expert opens the platform through the mobile software application or the web browser, an open session may be created between the client and a server. The server 1810 may be informed that the expert is available and may be provided with information such as location, time zone, latency and quality of data connection. Based on this information, the requestor may be connected to the closest expert for purposes of optimal speed, relevancy of expertise, and language.

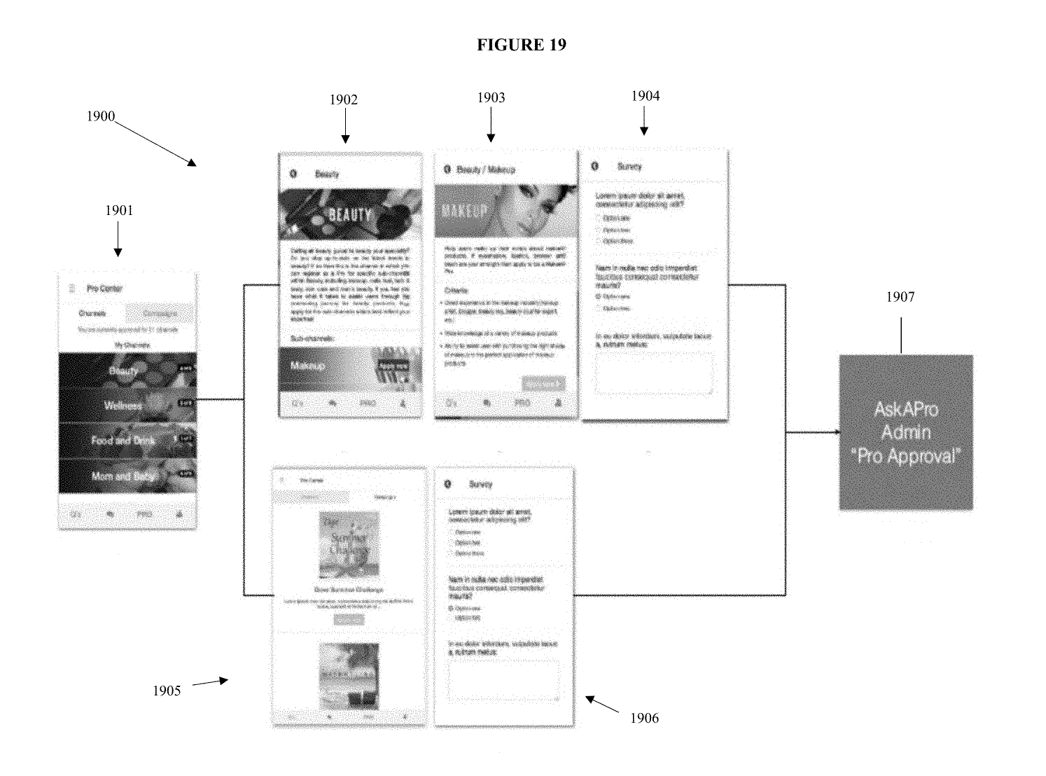

As shown in FIG. 19, an expert may apply via a series of screens 1900 to channels and campaigns of varying categories as shown in screens 1901, 1902, 1903 and 1905 run by clients such as companies. To be accepted into the channel or campaign, the expert may answer questions formulated by the company listed in a survey as shown in screens 1904 and 1906. The survey may be customized to include questions required to demonstrate suitable expertise such as professional accreditation by submission of professional certificates. Campaigns may be initiatives run by clients where they may entice experts to learn new information about products or services offered.

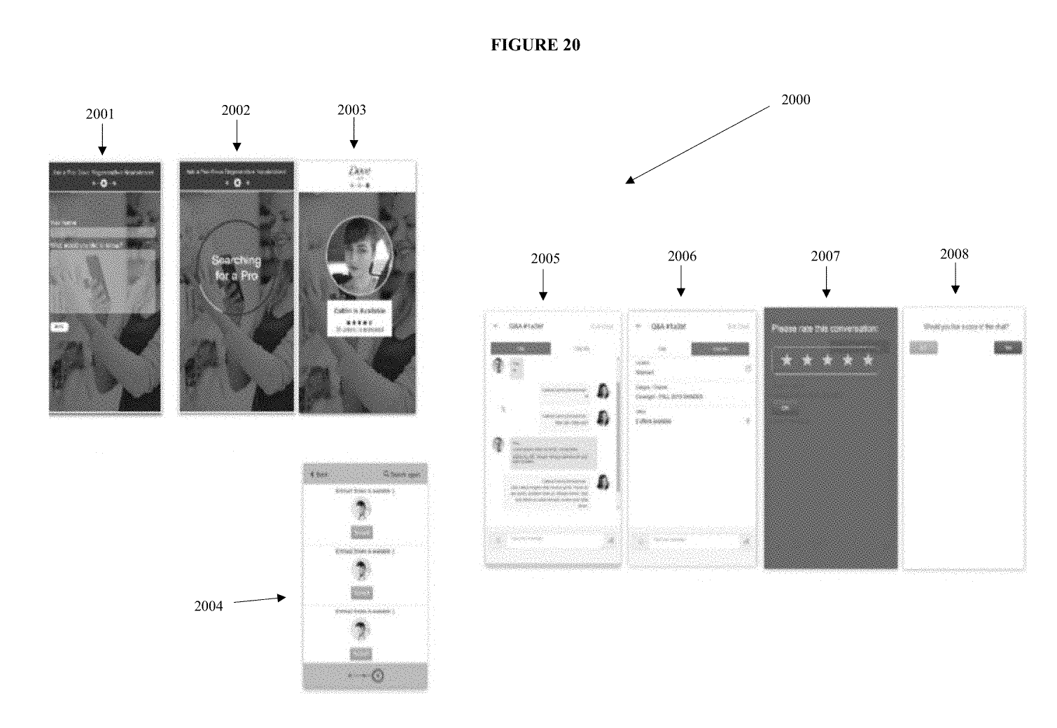

As shown in FIG. 20, a series of screens 2000 is shown where a requestor such as a consumer and an available expert may interact upon the consumer initiating an information request by asking a question regarding an object, such as a product or service or person, in screens 2001 and 2002. The consumer may either be delivered an exact match with one expert as in screen 2003 or a series of matches of experts as in screen 2004. Details such as channel, requestor and expert details may be viewed by the consumer or the expert. Following the interaction between the consumer and the expert in screens 2005 and 2006, the engagement may be completed. The consumer and the expert may rate the quality of the interaction as shown in screen 2007 and may choose to receive a copy of the interaction in its entirety as shown in screen 2008.

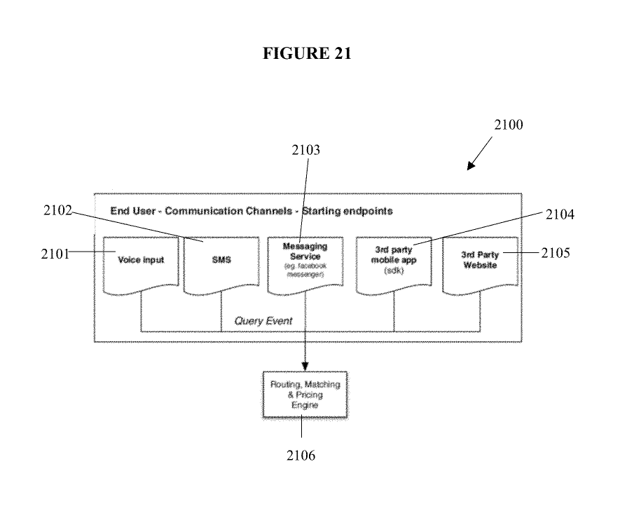

The consumer and the expert may use various communication channels to interact with each other. As shown in FIG. 21, communication channels may include voice input 2101, short message service (SMS) 2102, a messaging service 2103, a third party mobile application 2104 or a third-party website 2105.

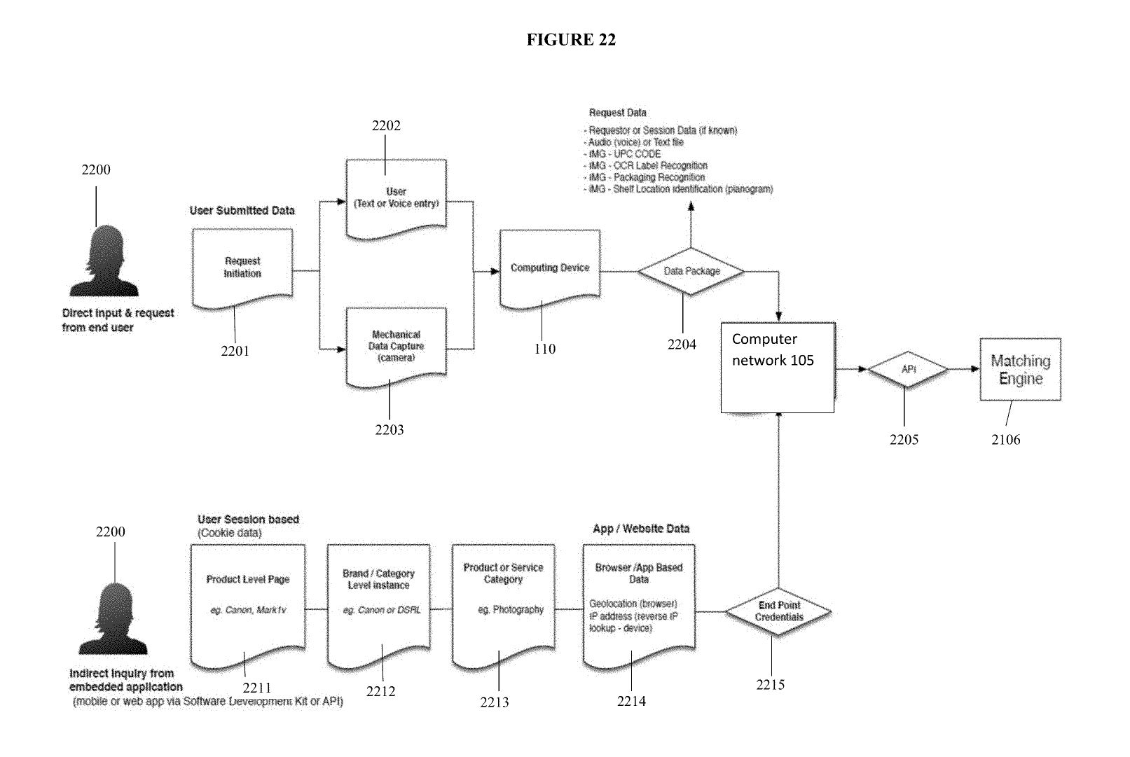

According to an embodiment, the consumer may initiate the process to engage an expert when desired in real-time. Advance screening using artificial intelligence solutions and machine learning may pre-process an input event to ensure optimal responses to consumers. As shown in FIG. 22, a consumer 2200 may input data for his or her information request directly. The consumer (requestor) may initiate the information request 2201 by either manually entering data into a text or voice dictation 2202 to define a parameter of the information request or may use an image capturing device 2203, such as an embedded camera on a smartphone or a tablet computer. Their computing device 110 may capture and transport a data package 2204 containing consumer or session data (if known), an audio (voice) or text file, one or more images of a UPC Code, OCR Label, packaging, or shelf location (planogram), to an appropriate communication channel from communication over a computer network 105, via an API 2205 to a matching engine 2106 for routing the information request.

As mentioned above, data may be gathered from a universal product code (UPC), which may be attached to a product. The UPC may contain a reference to a product category and other related packaging information that may be used for routing via the matching engine 2106. Data may also be gathered from an image captured by a camera attached to the image capturing device that may be processed using optical character recognition (OCR). This may allow the platform to effectively read a name of the product or service, which may be transcribed and matched. Further, data may be gathered from an image that may be matched against an image library to identify the appropriate product or service. Upon matching, relevant information about the product or service may be retrieved. Finally, data may be gathered from an image taken of a shelf in a store. The image may be matched against planned store designs to identify where the requestor is standing. A planned layout of store space planning in retail environments may be known as a planogram. Overall, a data may be extracted from each explicit data point submitted by the consumer to match against routing parameters pre-set within the matching engine based on clients.

As also shown in FIG. 22, a consumer 2200 may alternatively initiate an indirect inquiry when embedded in a third-party platform. A third-party platform may be a software platform, web-based application, smartphone application or messaging platform in which the platform may submit an information request via valid endpoint credentials to access a system API using a network transport layer, Wi-Fi or cellular network connection. For example, the requestor may visit a webpage displaying a specific product as shown in 2211. Browser session data may be captured via cookie to inform a chat agent of content such as type 2213, model 2211 and brand 2212 of the product, messaging session data 2214 such as language and browser version and metadata associated with the requestor visit such as Internet protocol (IP) address and location. The chat agent may assign the product to an expert who is available and qualified. The browser session data may be expressed as a series of variables with a uniform resource locator (URL) or cookie.

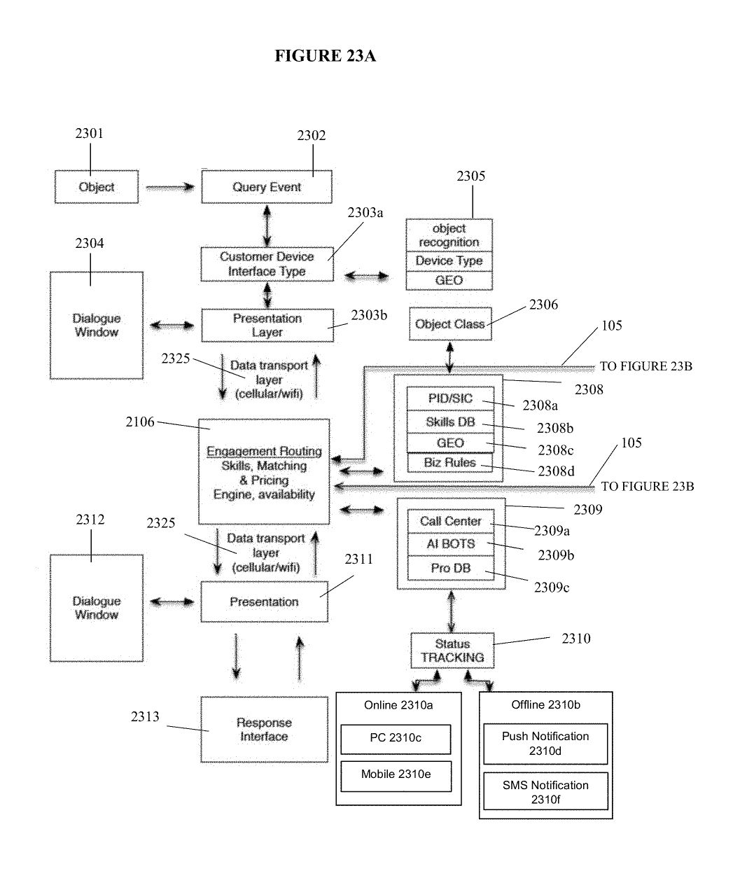

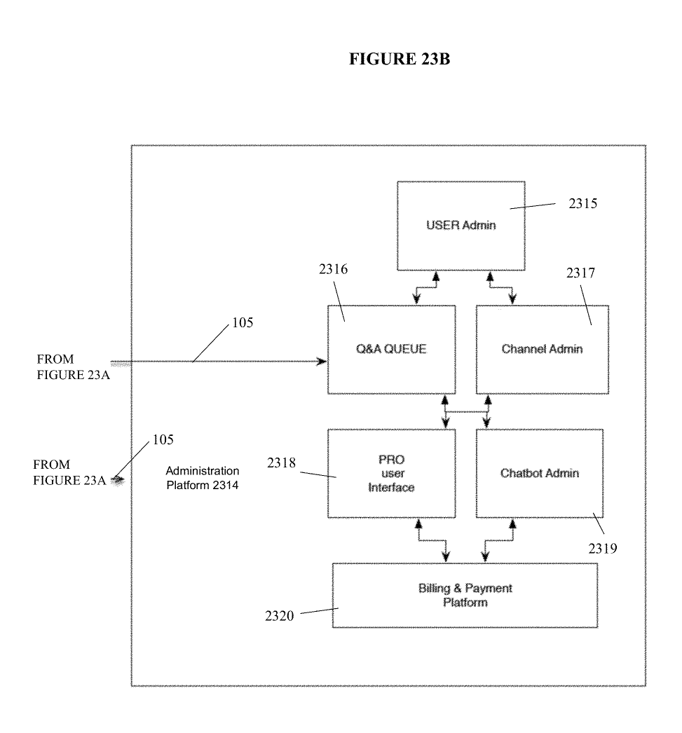

As shown in FIG. 23, an information request related to an object 2301 such as a person, place or thing may be initiated by a consumer or requestor (see FIG. 21). A query event 2302 may be initiated by the consumer requestor who may input data on through their device or interface 2303a to submit parameters of an information request using direct or indirect input (see FIG. 22) using a dialogue window 2304 rendered by the presentation layer 2303b. Object recognition, device type and geography 2305 as well as object class 2306 may be pre-processed and qualified for an engagement routing, matching and pricing engine 2106. The engagement engine 2106 may look at pre-defined system variables for returning appropriate matches between the consumer and an expert. Two parallel processes may be initiated, which may include queries 2308 examining a category of a product by examining product identification and extracting relevant product-related data 2308a, skills and knowledge database 2308b, special recognition 2308c such as proximity and time zones between the requestor and level of knowledge required by the expert, and business rules 2308d (see FIG. 15). Parallel queries and business rules may be executed and the platform may then be capable of assigning an inbound query to a channel 2309. The channel 2309 may include sending the query to a call center 2309a administered by the client, asking for further clarity or delivering a result using a chat robot 2309b that may be augmented with machine learning or artificial intelligence, or assigning the query to the expert 2309c. Conditional routing may be provided which refers to business rules within the matching engine that are applied as a result of how a channel is configured. Conditional routing may be applied by direct analysis of text of the information request and a machine learning algorithm to understand a keyword in context. For example, a conditional rule may examine an information request via SMS for pre-defined keywords. The query event 2302 may be transported to the engagement engine 2106 and then to a presentation layer 2311 by a data transport layer 2325.

A status tracking application 2310 may maintain a real-time status with respect to whether experts are available and logged in 2310a or offline 2310b. If the expert is online 2310a, the query event may be assigned to the expert, whether the expert is logged in on a personal computer 2310c or on a mobile device 2310e. If the expert is offline 2310b, the query event may be assigned to the expert, wherein the platform automatically triggers a push notification 2310d sent via messaging such as SMS 2310f, electronic mail or a messaging application to notify the expert of the query. The expert may accept the query (see FIG. 20), initiate a one-on-one chat 2312 with the consumer or requestor, and chat 2312 with the consumer or requestor through response window 2313 rendered by the presentation layer 2311. Business and programming logic of user interactions may be managed through an administration platform 2314 which may for example include a web-based user interface. The administration platform 2314 may include a user administrator 2315 (see FIG. 4), a question and answer queue 2316, and an expert administrator 2318 (see FIG. 9). The administration platform 2314 may also include a channel administrator interface 2317 and a chat robot automated administrator interface 2319. The chat robot automated administrator interface 2319 may allow custom chat robot integrations or a third-party chat robot created and maintained by a third-party developer or company. The platform may also include a billing and payment application 2320, wherein a client (i.e. typically a brand) may be charged for access to the platform and process completed engagements.

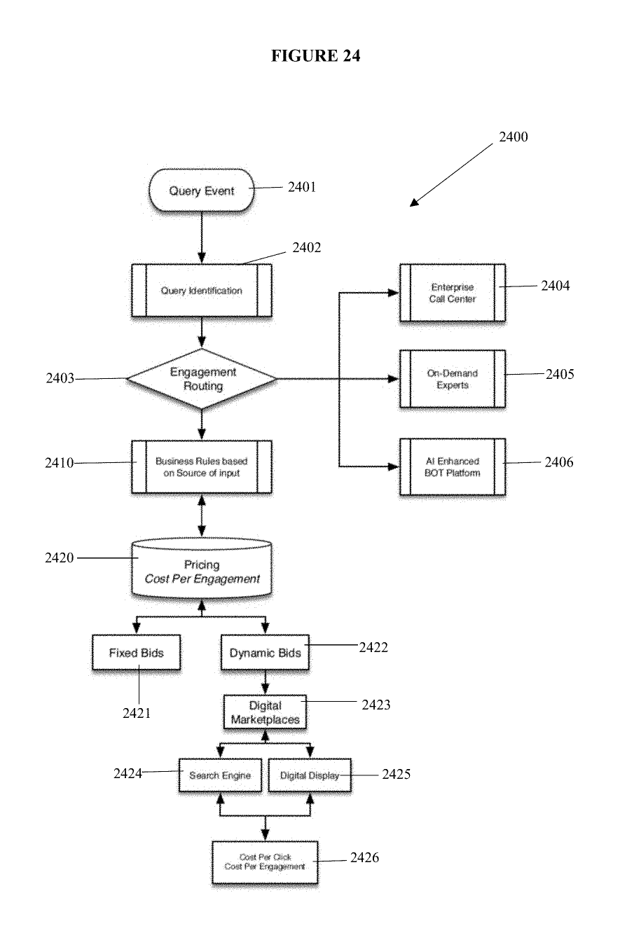

Experts may require a form of remuneration and automated computer-based agents (as an alternative to a human expert) may require financial remuneration as an incentive to be available and online. A dynamic real-time pricing platform may be provided that may be both channel and platform agnostic real-time fair market value for consumer engagement as it relates to knowledge-based interactions. As shown in FIG. 24, an interaction value may be calculated between the consumer or requestor and the expert through multi-stage optimization. Multi-stage optimization may include pre-defined fixed pricing and/or dynamic pricing and price discovery. Multi-stage optimization may further include comparing the cost of an exchange to the cost per click or cost per engagement in another online media exchange or platform in real-time. A query event 2401 and a query identification event 2402 may be initiated. The query event and the query identification event may combine to form a basis for engagement routing 2403 where predefined business rules 2410 may be applied to identify a channel for response such as a call center 2404, an on-demand expert 2405 or an artificial intelligence-enhanced robot platform 2406 and in parallel pricing the cost per engagement 2420 for the expert.

Pricing for cost per engagement may be initially determined by two methods: fixed bids 2421 or dynamic bids 2422. Fixed bids 2421 may be determined in advance and configured in an administration portal. Dynamic bids 2422 may be set based on a series of variable criteria. Queries may require varying degrees of knowledge such as expert, professional and lay person and there may exist competition between multiple clients seeking to employ experts for their channels. A proxy may be created for the cost per engagement by examining the value of interactions in other real-time marketplaces. Other marketplaces may be digital display advertising, cost per click or cost per view of a video, or cost per click in Google AdWords.

According to an embodiment, an intelligent agent may be embedded using a software development kit (SDK) into proprietary third party applications. Input methods may include text, voice or images. An identification engine may include three vectors; explicit data entry, which may be by virtue of an image, a UPC, and a question type, a location and identity from which the question originates, and an input device such as an image capturing device. A rules engine may include extracted data from the matching phase, which may identify a query type and match the query type to a corresponding code such as a UPC. A synchronization engine may be a software-matching engine, wherein the software-matching engine may be engaged to complete the identification and matching phases. Active experts may receive notifications that match their designation. Each expert may be assigned with one of three states: passive, active and high. Passive notifications may include messages that do not require an immediate response and are sent by mediums such as electronic mail. An active state may be a state where the expert is available in real-time and receives notifications to engage a requestor directly via chat or another means. High state notifications may route real-time voice to voice or video connections between the expert and the requestor. The expert's and the requestor' s location, global positioning system (GPS) coordinates and IP address may be disclosed. The most often used mode of communication between the expert and the consumer or requestor may be used as a default in the high state when there may be an urgency of communication.

An interaction between the expert and the consumer or requestor may be output, if not marked private, as hypertext markup language (HTML) to create an extensible markup language (XML) or an HTML markup document to create a data tree associated with the object. Meta data markup may include resource description frameworks (RDF), micro format and semantic language markup, which may create materials for future reference to answer a consumer's query in advance and may be used to further enhance the identification phase. The consumer may initiate the interaction from a device with any level of connectivity. A format of the interaction may be embedded directly into third party websites, third party mobile applications or triggered by SMS.

According to an embodiment, advanced query identification and response may comprise the ability to run a series of micro-services which are executed at the point of query submission. A basic example is creating a fixed rules system where the query input defines the query routing. For example, suppose query input equals a text message 2202 to a predetermined SMS short code which is bound to a specific engagement routing 2106 to a call center in channel 2309.

According to an embodiment, the platform presumes to learn from previous engagements to optimize by applying systematic updates via machine learning to the underlying system responsible for query identification as shown in FIG. 23. On the first submission of a query the platform attempts to exact as much explicit (user entered data) and implicit data available (extracted from the device, location based data, image data, and business rules). The query identification system then may submit the data to machine learning enhanced micro-processes that are batched in parallel to determine the correct engagement routing. Each micro-process submits its score and business rules which are applied in real-time to form an output which guides the engagement routing. Correct engagement routing is not guaranteed unless it is a predetermined. The system also may take the post-engagement output results and perform post engagement analysis which in turn has an output that may update all the relevant anteceding micro-processes. As a result, the second time the same query is received the likelihood of responding correctly may be higher.

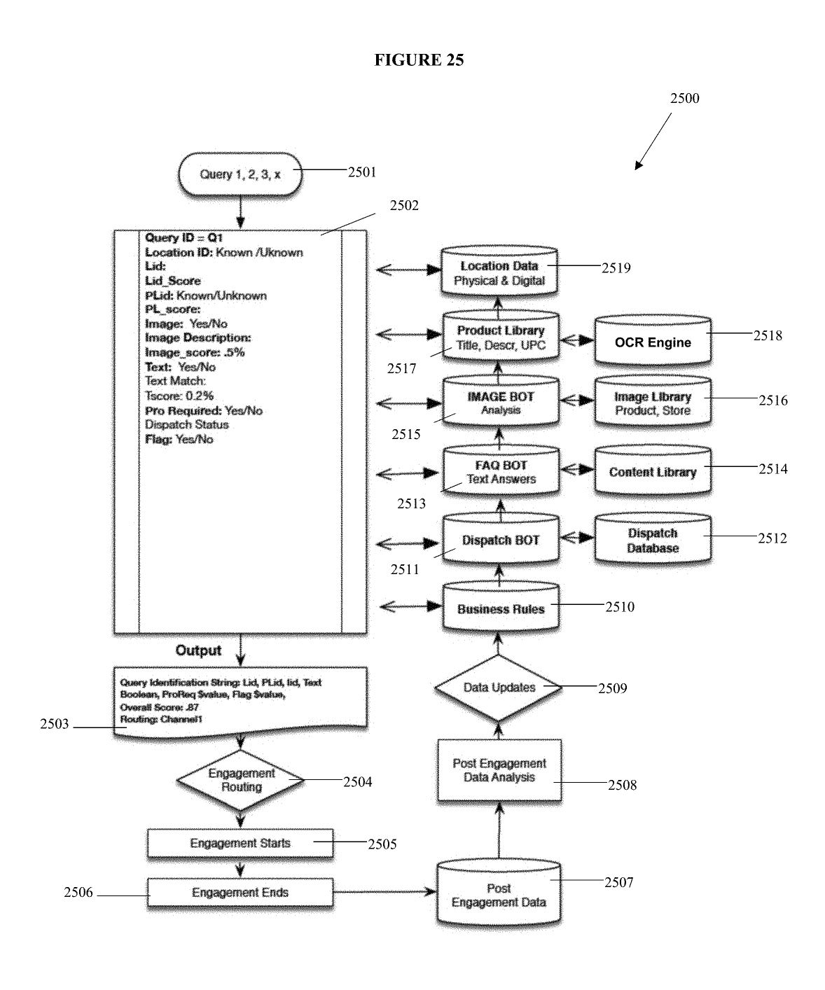

According to an embodiment as shown in FIG. 25, a flow diagram 2500 for advanced query identification and continuous optimization through machine learning may begin with a query 2501 initiated by the consumer or requestor. The platform may attempt to extract as much query data 2502 as is available including data from using business rules 2510, dispatch data 2511 from a dispatch database 2512, frequently asked question (FAQ) data 2513 from a content library 2514, image data 2515 from an image library 2516, product data 2517 such as title, description and UPC from an OCR engine 2518, and location based data 2519. The query identification system then may output data 2503 for engagement routing 2504, wherein after routing the engagement may start 2505 and later the engagement may end 2506. Post-engagement data 2507 may be collected and undergo post-engagement data analysis 2508 which in turn results in an output 2509 that may be used update all the relevant anteceding micro-processes. A few examples are discussed below.

According to a test case #1, a consumer is standing in a pharmacy using an embodiment of the invention as herein described embedded within the pharmacy's own mobile app to take a picture of an unknown item and submits the following text “Is this safe for children?”.

The query #1 submission data may include: Location Data (Pharmacy X App), Product Name (via attempted extraction through Optical Character Recognition (OCR)), Image Upload (attempted matching against a library of images available in the pharmacy X catalogue), and Text (is this safe for children?). Upon executing the query identification, the product is correctly identified as Tylenol™, correctly matched against the image in the database but the system notes a keyword flag “Children” associated with a “DIN” product Drug Identification Number. As a result, the engagement may be routed to a call center. The engagement may then be handled by the call center. Once the post engagement data is subsequently processed and completed scores for each micro-service response. The system may now respond faster and with greater confidence should the same query be submitted as query #2. It may also be assumed that as the volume of post engagement data grows, the accuracy of responses increases through the application of continuous machine learning. This would in turn allow system administrators to approve and forgo routing questions to the call center once the system achieves a consistent degree of accuracy and proficiency having answered a question multiple times.

Using another query as an example, query #2, a digital photographer who is interested in buying a Hasselblad™ camera at a third-party retailer wants an unbiased opinion from a third party who currently shoots with Hasselblad™ cameras. According to an embodiment, the platform would recognize that the input query as Qid2; Location: https://www.bhphotovideo.com/c/product/1244709-REG/hasselblad_h_3013742_h6d_100c_medium_format_dslr.html, Receiving a PLid=Hasselbad_H6d, and text includes “What are the advances of having multiple stops on a camera and how does it compare to previous model?”. Due the qualitative nature of the question the query would pass text analysis but automatically search for a real-would responder. This is where a significant difference occurs between a traditional chat platform (1:1) and dynamic machine learning. The dispatch platform could recognize various on-demand pros within its database who are tagged as “digital”, “photographer”, “professional” and also subsequently calculate which “pro” is closest geographically to the digital photographer with the question and also theoretically “available” or “online” so as to return the fastest possible response. Once the pro is identified the query identification output may include engagement routing criteria to create a real-time connection between the digital photographer and the available on demand pro. Once the interaction is complete the post engagement process begins where the content of the discussion (by text, voice or video) is analyzed creating new content for the system and also updating the profile and score of the pro and potentially ascribing similar scores to other pros within the platform who fit a similar data profile.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A computer-implemented method for providing on-demand expert advice through a computer communication network to a consumer operating a network-connected computing device, the method comprising:
receiving an information request relating to an object from the computing device of the consumer;
analyzing the information request to identify at least one skill required to knowledgeably respond to the information request;
matching the information request with an available expert having the at least one skill required to knowledgeably respond to the information request;
sending the information request to the available expert so the available expert may engage with the consumer; and
following conclusion of the engagement between the consumer and the available expert, determining a price for the engagement to be remitted to the available expert.

2. The method of claim 1, wherein matching the information request with an available expert having the at least one skill required to knowledgeably respond to the information request comprises querying a database including one or more experts each having one or more skills.

3. The method of claim 1, wherein matching the information request with an available expert having the at least one skill required to knowledgeably respond to the information request comprises querying the availability of the one or more experts through a status tracking application.

4. The method of claim 1, wherein the information request is sent by the consumer by one of: voice input, SMS, a messaging service, a third party mobile application and a third party web site.

5. The method of claim 1, wherein the engagement between the consumer and the available expert comprises communications facilitated by a network-connected computer server.

6. The method of claim 1, wherein the available expert is an artificial intelligence-enhanced robot platform.

7. The method of claim 1, wherein determining a price comprises using fixed bids.

8. The method of claim 1, wherein determining a price comprises using dynamic bids.

9. The method of claim 1, wherein determining a price comprises using price discovery of cost per click or cost per engagement in another online platform in real-time.

10. The method of claim 1, wherein matching the information request comprises matching with the available expert based on category and level of expertise.

11. A computer system for providing on-demand expert advice through a computer communication network to a consumer operating a network-connected computing device, the computer system comprising:
a computer communication network;
a consumer computing device connected to the computer communication network;
a computer server connected to the computer communication network, the server including computer-readable instructions, which when executed configure the computer server to:
receive information requests from the consumer computing device;
analyze the information request to identify at least one skill required to knowledgeably respond to the information request;
match the information request with an available expert having the at least one skill required to knowledgeably respond to the information request;
send the information request to the available expert so the available expert may engage with the consumer; and
following conclusion of the engagement between the consumer and the available expert, determine a price for the engagement to be remitted to the available expert; and
at least one computing device operated by the available expert connected to the computer communication network.

12. The system of claim 11, further comprising a database in communication with the computer server including one or more experts each having one or more skills, wherein matching the information request with an available expert having the at least one skill required to knowledgeably respond to the information request includes the computer server querying the database.

13. The system of claim 11, wherein matching the information request with an available expert having the at least one skill required to knowledgeably respond to the information request comprises querying the availability of the one or more experts through a status tracking application.

14. The system of claim 11, wherein the consumer computing device is one of: a smartphone, a tablet computer and a desktop computer.

15. The system of claim 11, wherein the information request is sent by the consumer on the consumer computing device by one of: voice input, SMS, a messaging service, a third party mobile application and a third party website.

16. The system of claim 11, wherein the engagement between the consumer and the available expert comprises communications facilitated by the computer server.

17. The system of claim 11, wherein determining a price comprises using fixed bids.

18. The system of claim 11, wherein determining a price comprises using dynamic bids.

19. The system of claim 11, wherein determining a price comprises using price discovery of cost per click or cost per engagement in another online platform in real-time.

20. A computer program product for providing on-demand expert advice through a computer communication network to a consumer operating a network-connected computing device, the computer program product comprising:
a storage medium configured to store computer-readable instructions;
the computer-readable instructions including instructions for,
receiving an information request relating to an object from the computing device of the consumer;
analyzing the information request to identify at least one skill required to knowledgeably respond to the information request;
matching the information request with an available expert having the at least one skill
required to knowledgeably respond to the information request,
sending the information request to the available expert so the available expert may engage with the consumer; and
following conclusion of the engagement between the consumer and the available expert, determining a price for the engagement to be remitted to the available expert.
